(19) United States
(12) Patent Application Publication
(10) Pub. No.: US 2014/0020566 A1
(43) Pub. Date: Jan. 23, 2014

(54) BEVERAGE DISPENSER WITH IMPROVED NOZZLES ASSEMBLY

(71) Applicant: Michael (Mischa) Stieger, Orbe (CH)

(72) Inventor: Michael (Mischa) Stieger, Orbe (CH)

(73) Assignee: NESTEC S.A., Vevey (CH)

(21) Appl. No.: 14/008,937

(22) PCT Filed: Mar. 19, 2012
(86) PCT No.: PCT/EP2012/054842

§ 371 Date: Sep. 30, 2013

(30) Foreign Application Priority Data
Mar. 30, 2011 (EP) 11160355.1

(51) Int. Cl. A47J 31/46; A47J 31/44

(52) U.S. Cl. CPC A47J 31/46; A47J 31/4403
USPC 99/300; 29/426.1

(57) ABSTRACT

The invention concerns a beverage production device for preparing a beverage by introducing at least one liquid in a receptacle (13) containing a beverage concentrate, said beverage production device comprising: a plurality of nozzles (3, 40, 8, 11) for injecting at least one liquid into the receptacle, and at least one liquid supply means (5, 6)connected to said nozzles, wherein the nozzles are removably fixed in a positioning device (1) said positioning device being made of a flexible material.

### FIELD OF THE INVENTION

The present invention relates to a device for preparing a beverage from a food substance provided in a receptacle. In particular, the invention relates to such a device which enables the preparation of a beverage from a beverage concentrate which is provided to a receptacle by supplying diluents jets to the receptacle.

### BACKGROUND OF THE INVENTION

It is known to prepare beverages by mixing a beverage concentrate such as a dry powder and a diluent such as cold or hot water. Thereby, the following principle is generally applied for the beverage preparation. A beverage concentrate such as a dry powder is introduced into a receptacle such as a coffee or tea cup. Then, the cup is placed below an outlet of a dilution and mixing device which introduces at least a stream or jet of water to the cup in order to enable an interaction of the beverage concentrate and the hot water. Accordingly, the beverage concentrate is dissolved and eventually frothed by the hot water in order to prepare a beverage. However, the existing beverage preparation devices which make use of the above outlined principle suffer the inconvenience that the beverage concentrate is not fully diluted and thus, residua of the concentrate are present in the prepared beverage. This leads to a non-uniform and thus to a non-inviting appearance of the prepared beverage.

In addition, during provision of beverage concentrate to a receptacle, parts of the concentrate may stick to the inner side walls of the receptacle and can thus not be fully dissolved in the beverage preparation process. Moreover, if the beverage concentrate is not fully dissolved in the diluent provided to the receptacle, the taste of the beverage may vary from the intended beverage taste. Hence, particularly for the beverage preparation of hot beverages such as tea or coffee, it is desired to have a reproducible strength respectively concentration of the beverage to be prepared, wherein the concentration of the beverage corresponds to the amount of beverage concentrate provided to the receptacle and does not vary for each preparation. Therefore, a device for the preparation of a beverage according to the above stated principle is sought-after, which enables a full dissolution of the whole amount of beverage concentrate provided to the receptacle.

WO 2010/034722 describes a device and a method for allowing an efficient beverage preparation on the basis of food concentrate provided to a receptacle which is mixed with hot water supplied by a jet dissolving device. The jet dissolving device comprises a plate member comprising at least four nozzles for injecting a diluent jet into the receptacle said nozzles presenting specific different orientations relatively to the cup to get an efficient mixing and frothing. This plate member can also comprise:
a spray nozzle which is designed to provide a spray to the receptacle,
an outlet in connection with a coffee mixing chamber for injecting coffee into the receptacle,
one additional nozzle of bigger outlet diameter compared to the other nozzles for providing a larger amount of diluent at low pressure to the receptacle compared to the case wherein a smaller outlet diameter nozzle is applied.

In this device several of the nozzles in the plate member are connected to a source of hot or cold water and the plate member is also connected to the outlet of a coffee mixing chamber which creates a congested space above the plate member. When the jet dissolving device must be maintained for reparation or hygienic cleaning, the whole device must be disconnected even if the maintenance concerns only one of the nozzles, which is not operator friendly.

It has also been observed that during the preparation of the beverage drops can be sent up from the container on the bottom face of the plate member. Due to the presence of numerous nozzles rising to said surface, the cleaning can be difficult.

Moreover it has been noticed that it can be difficult to adapt and improve such an existing device: due to the fact that each nozzle place is definitively set, the implementation of new improvements relative for example to the orientation of the different nozzles is very limited.

One aim of the present invention is to solve these problems and to propose a jet dissolving device of a beverage dispenser which can be easily and rapidly assembled, dismantled for maintenance and then put together again.

Another aim of the present invention is to propose such a jet dissolving device of which sub-units can be easily improved without a need to design the whole device again.

Another aim of the present invention is to propose such a jet dissolving device of a beverage dispenser which can be easily cleaned.

Another aim of the present invention is to propose such a jet dissolving device of a beverage dispenser in which the space above the plate member can be lightened.

### SUMMARY OF THE INVENTION

According to a first aspect, the invention concerns a beverage production device for preparing a beverage by introducing at least one liquid in a receptacle containing a beverage concentrate, said beverage production device comprising:
a plurality of nozzles for injecting at least one liquid into the receptacle, and
at least one liquid supply means connected to said nozzles,
   wherein the nozzles are removably fixed in a positioning device said positioning device being made of a flexible material.

The invention relates to the beverage dispensers preparing a beverage from at least one soluble food or beverage ingredient. The food ingredient is first delivered in a receptacle and then a liquid diluent—usually water—is introduced in the receptacle for dissolving the ingredient. In order to improve dissolution of the food ingredient and eventually simultaneously frothed the beverage, the diluent can be introduced by a plurality of nozzles connected to diluent supply means. It is also possible to introduce through at least one of the nozzles a liquid that is a beverage that has been prepared or stored in another part of the dispenser in order to get a mixture of beverages in the receptacle. For example most of the nozzles can be dedicated to the introduction of water for dissolving and frothing a milk powder in the receptacle and one nozzle can be dedicated to the introduction of coffee prepared in a separate mixing chamber so that a milk and coffee beverage can be produced in the receptacle.

In the present invention the positioning device aims at positioning the nozzles one relative to the others and fixing them in their operative positions. The positioning device can also orientate the nozzles relative to the vertical. The positioning device generally presents holes for removably plugging the nozzles so that the nozzles can go right through the positioning device. These holes preferably present inside dimensions corresponding to the external dimensions of their respective nozzles. Then tightness can then be optimized. Moreover it is possible to design the different couples of hole and corresponding nozzle with different dimensions so that during maintenance and reconnection of the nozzles in the positioning device, the operator can immediately identify to which hole each nozzle must be connected. Depending on the dispenser the correct connection of a hole and a nozzle can be important because the positioning of the different nozzles can affect the effective dissolution of the food or beverage ingredient in the receptacle. A misconnection could lead to a deficient dissolution or frothing.

According to a preferred embodiment, at least one of the nozzles can present at least one annular flange fitting in at least one annular recession of its respective hole in the positioning device when said nozzle is fixed in the hole.

The flexible material can be a rubber or a soft thermoplastic. Preferably the flexible material of the positioning device is an elastomeric or silicone material. By flexible material, it is meant that the material is soft, distortable and resilient.

According to a specific embodiment the positioning device can present a flat bottom surface and the nozzles can be fixed so that they slightly project beyond said bottom surface.

The positioning device can be fixed in a beverage production machine so that either its bottom surface directly faces the container in which the beverage is prepared or its bottom surface can rely on a housing plate member of the machine comprising holes corresponding to the nozzles outlets slightly projecting beyond the positioning device bottom surface.

In general the nozzles are connected to liquid supply means through flexible tubes.

According to a specific embodiment, at least one of the nozzles removably fixed in the positioning device can be an assembly of sub-nozzles connected to a common diluent supply means. Generally the assembly of sub-nozzles comprises at least 4 sub-nozzles, preferably between four and height sub-nozzles. At least two of the sub-nozzles can be designed to direct a diluent jet to an inner side wall of the receptacle and said sub-nozzles can be arranged at different angles (α) with respect to the vertical, and at least two of the sub-nozzles can be designed to direct a diluent jet to the bottom of the receptacle and said sub-nozzles can be arranged at different angles (β) with respect to the vertical. This assembly of sub-nozzles can comprise an outer body made of a rigid material and an inner body made of a flexible material and wherein the channels of the sub-nozzles are hollowed in the inner body and wherein the outlets of said channels extend through the bottom of the outer body and slightly project beyond the outer body bottom surface. The outer body can be a tube of which one end is a plate comprising traversing holes for receiving the outlets of the nozzles channels of the inner body. Preferably the inner body presents dimensions such that it is able to slide in and out of the outer body. The inner body is preferably made of a flexible material which can be an elastomeric or silicone material. According to another preferred embodiment the assembly of sub-nozzles can comprise a removable connection to a liquid supply means. The removable connection is preferably part of the outer body. The removable connection usually cooperates with corresponding connection means of the liquid supply means. These means can be e.g. clipping or screwing means. According to a particular mode the sub-nozzles assembly can comprise a channel for guiding the liquid to the channels of the sub-nozzles.

At least one of the nozzles removably fixed in the positioning device can be a spray nozzle which is designed to provide a spray to the receptacle. Usually the spray nozzle is supplied with water.

According to a specific and preferred embodiment, at least one of the nozzles removably fixed in the positioning device can the outlet of a beverage mixing chamber in which a beverage can be separately prepared and finally mixed with other beverage components in the receptacle. The beverage mixing chamber is preferably a coffee mixing chamber. Usually except the at least one nozzle that is the outlet of a mixing chamber, all the other nozzles are connected to the same liquid supply means, preferably water.

According to a second aspect the invention also concerns a method for quick disconnecting or fastening a plurality of nozzles of a beverage production device for injecting at least one liquid into a receptacle comprising:
providing a positioning device made of a flexible material and comprising holes for removably plugging the nozzles,
unplugging or plugging the nozzles in holes of the positioning device.

In the present application, the terms “top” and “bottom” must be understood according to the orientation of the beverage mixing device in its position of use that is the outlet of the nozzles orientated downwards.

### BRIEF DESCRIPTION OF THE DRAWINGS

The characteristics and advantages of the invention will be better understood in relation to:

FIG. 1 is a schematic diagram of a beverage production device according to the prior art.

FIG. 2 is a perspective top view of a beverage production device according to the prior art.

FIG. 3 depicts a perspective view of a beverage production device according to the invention.

FIG. 4 is a bottom view of the beverage production device of the present invention.

FIGS. 5 and 6 are respectively top and bottom views of the positioning device of the beverage production device of the present invention.

FIGS. 7 and 8 are perspective views of the beverage production device of the present invention wherein the positioning device has been made transparent.

FIG. 9 is an exploded view of an assembly of sub-nozzles that can be fastened in the positioning device of the beverage production device of the present invention.

### DETAILED DESCRIPTION OF THE DRAWINGS

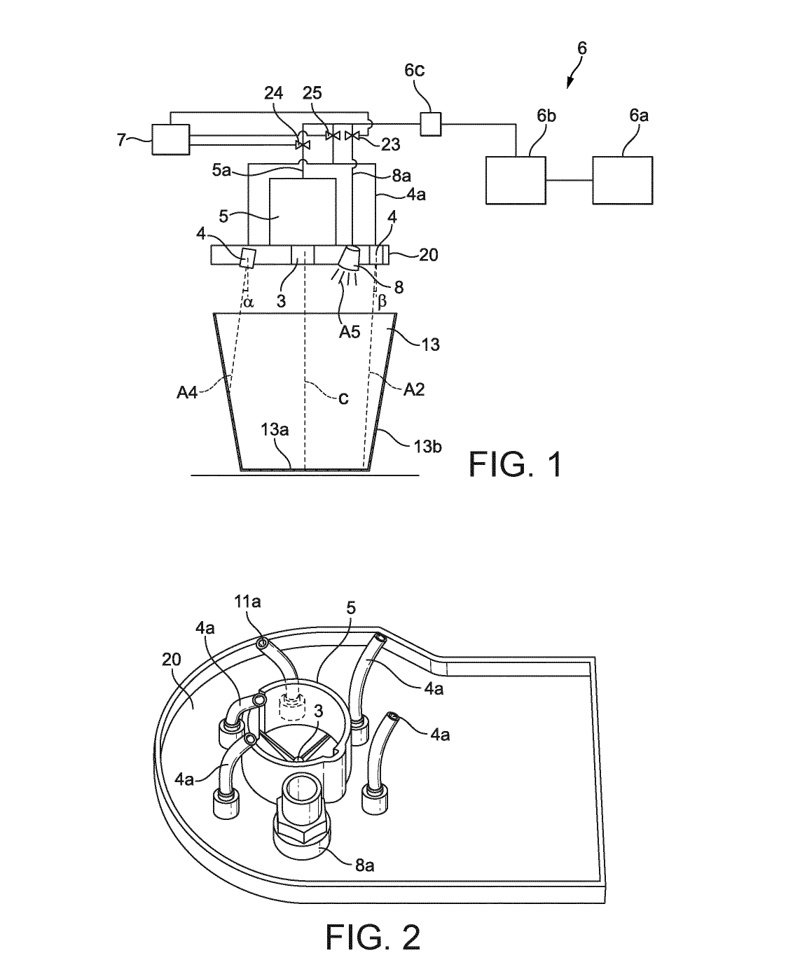

FIG. 1 is a schematic view of a dissolution device of a dispenser according to the prior art. As can be seen in FIG. 1, a plate member 2 comprises four nozzles 4 (only 2 are illustrated). In addition, the plate member comprises an outlet 3 which is in fluid connection with a coffee mixing chamber 5 which is mounted on the plate member. The plate member 2 preferably comprises a spray nozzle 8 which is designed to inject a spray A5 towards a receptacle placed beneath the plate member 2. The nozzles 4, the spray nozzle 8 and the mixing chamber 5 are in fluid connection to diluent supply means 6 of the device. The diluent supply means preferably comprise a water tank 6a respectively a reservoir suitable for providing a diluent to the device. It should be noted that instead of a reservoir, the device may be connected to a water tap in order to establish a permanent diluent supply. The diluent supply means comprise a pump 6b which is in connection to the reservoir and which provides diluent to a boiler 6c of the water supply means 6. Thereby, instead of a boiler, a thermo block or other suitable heating means may be provided. According to this embodiment, the water supply means are designed for supplying a heating pressurized diluent. In a preferred embodiment however, a by-pass water path (not shown) may be provided in order to by-pass the heating means 6c and thus for providing a pressurized cold water to the nozzles 4 respectively to the spray nozzle 8. The fluid connection between the diluent supply means 6 and the nozzles 4 respectively the spray nozzle 8 and the mixing chamber 5 is established by means of tubular members 4a, 5a, 8a which are schematically shown in FIG. 1. Within the fluid connection between the mixing chamber 5, the nozzles 4 and the spray nozzle 8, valve members 23, 24, 25 are arranged. The valve members have at least an open and a closed position in which a diluent flow from the diluent supply means to the outlet nozzles 4, the spray nozzle 8 or the mixing chamber 5 is enabled or disabled respectively. Thereby, the valve members 23, 24, 25 are preferably connected to a control unit 7 which controls the position of the valve members. Accordingly, diluent may be selectively provided to the nozzles 4, the spray nozzle 8 and the mixing chamber 5. However, it may as well be possible to have only one valve member, e.g. valve member 23, connected between the diluent supply means 6 and the nozzles 4. Thereby, the nozzles 4 are in fluid connection to a single tubular member, e.g. tubular member 4a, connected to the valve member 23. The tubular member 4a may for example be connected to a circular channel in the plate member 2, said circular channel emerging in the different outlet nozzles. Due to the outlet nozzles 4 being in fluid connection to the tubular member 4a, distribution of diluent from the tubular member 4a to the outlet nozzles 4 is enabled. It should be understood that the outlet nozzles 4 may comprise any means suitable for directing a fluid jet towards the receptacle 13. The holes of the nozzles can be of different size to provide different water pressures.

However, the outlet nozzles may as well be formed as an integral part of the plate member, such as for example holes formed in the plate member 2.

As can be seen in FIG. 1, a diluent supply to the nozzles 4 results in a jet of diluent A2, A4 being ejected from the corresponding nozzles 4. Thereby, the outlet nozzles are preferably arranged at the plate member 2 such that the fluid jets A2 is directed to a bottom portion 13a of a receptacle 13 placed on a support means 10 beneath the plate member 2. Moreover, at least one of the nozzles 4 is arranged such that the ejected fluid jet A4 hits a sidewall portion 13b of the receptacle 13. Thereby, the fluid jet which is directed to a bottom portion 13a of the receptacle 13 provides the essential force for dissolving a food substance which is preferably provided in powder form to the receptacle. Moreover, the fluid jet directed to a sidewall portion 13b of the receptacle is able to prevent food substance from sticking to the sidewall of the receptacle. At the centre of the plate member 2, the outlet 3 delivers a jet of coffee C from the coffee mixing chamber 5.

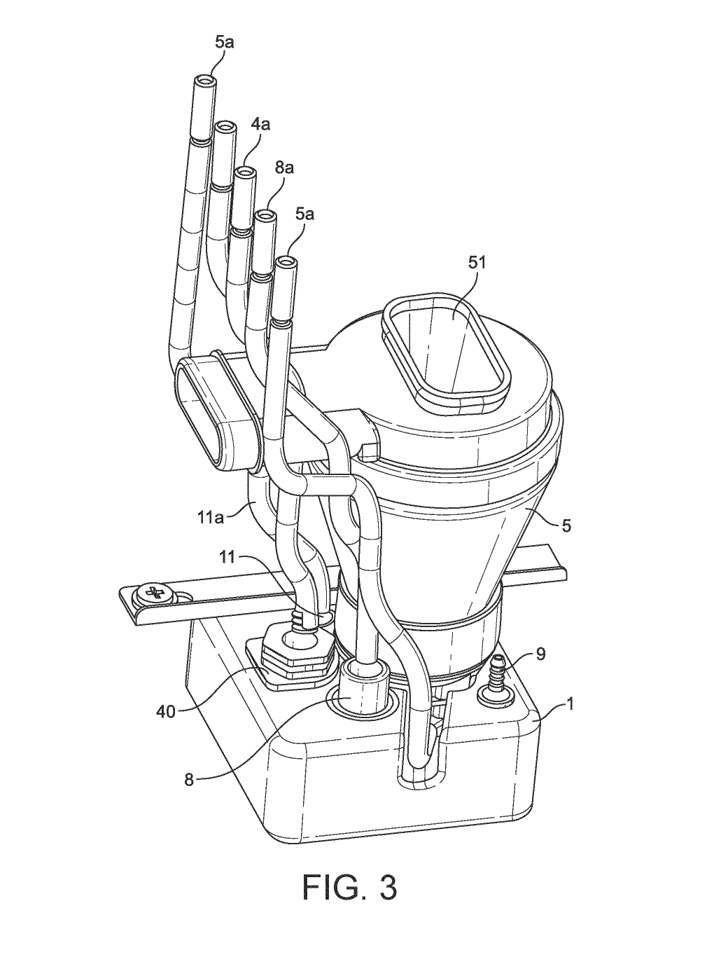

FIG. 2 is a top view of the plate member 2 to which the tubular members 4a, 5a, 8a supplying the outlet nozzles and the spray nozzle are connected according to the prior art. The coffee mixing chamber 5 lies on the plate so that its outlet emerges through the plate. The tube 11a supplies an additional nozzle which preferably has a greater outlet diameter than the other nozzles.

It is apparent from this figure that all the nozzles are definitively fixed to the plate member and cannot be changed or cleaned without dismantling the plate member from the dispenser. Moreover this figure shows how the space above the plate member is congested.

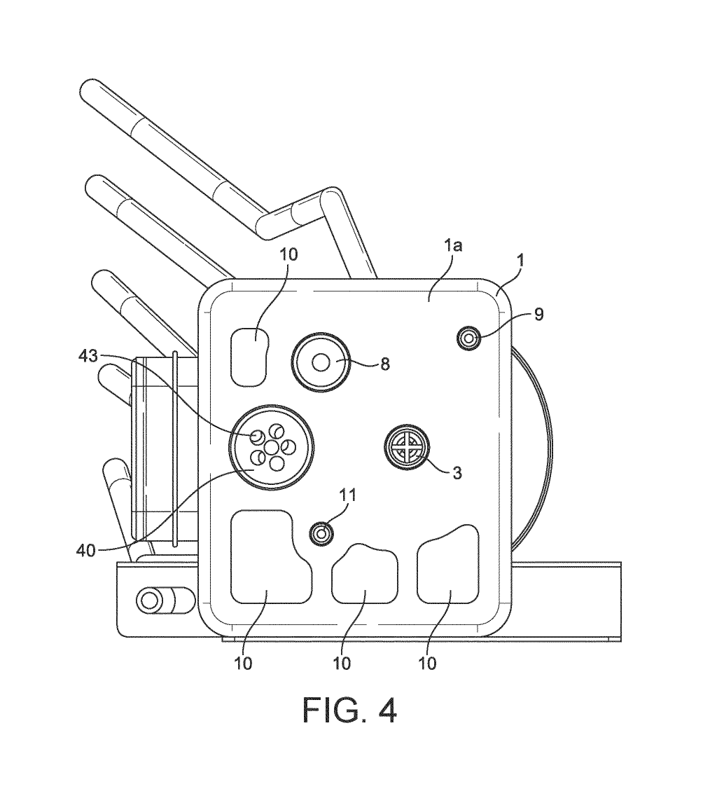

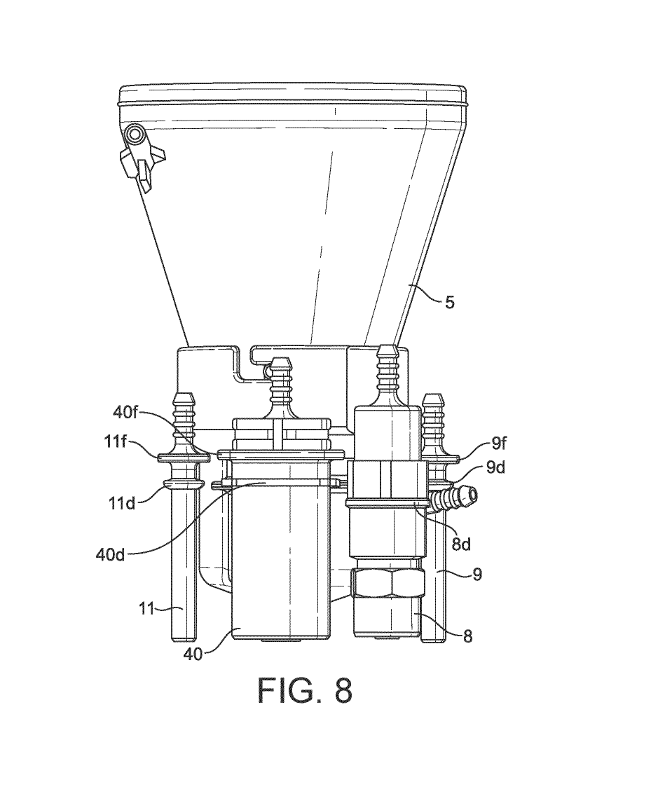

FIG. 3 is a top perspective view of a beverage production device according to the invention. The device comprises a chamber 5 for mixing a soluble powder, preferably a coffee powder, with a diluent, usually water. The soluble powder is introduced through the chamber top opening 51 and the diluent is introduced through two tubular members 5a. Preferably the diluent is radially introduced in the mixing chamber in order to create turbulence to get sufficient mixing and dissolution of the powder in the diluent. Preferably the mixing chamber can present the design of the chamber described in WO 2008/071613. The outlet of the mixing chamber (referenced as 3 in FIG. 7) is positioned in a positioning device 1. This positioning device 1 is also designed for positioning four nozzles 40, 8, 9, 11, respectively connected to tubular members 4a, 8a, 9a (not illustrated) and 11a for introducing a diluent, preferably water. The mixing chamber enables the production of a first beverage, e.g. coffee, that can be mixed with a second beverage prepared in the container 13, e.g. milk. In the present invention a nozzle corresponds to a fitting attached at the outlet of a tubular member.

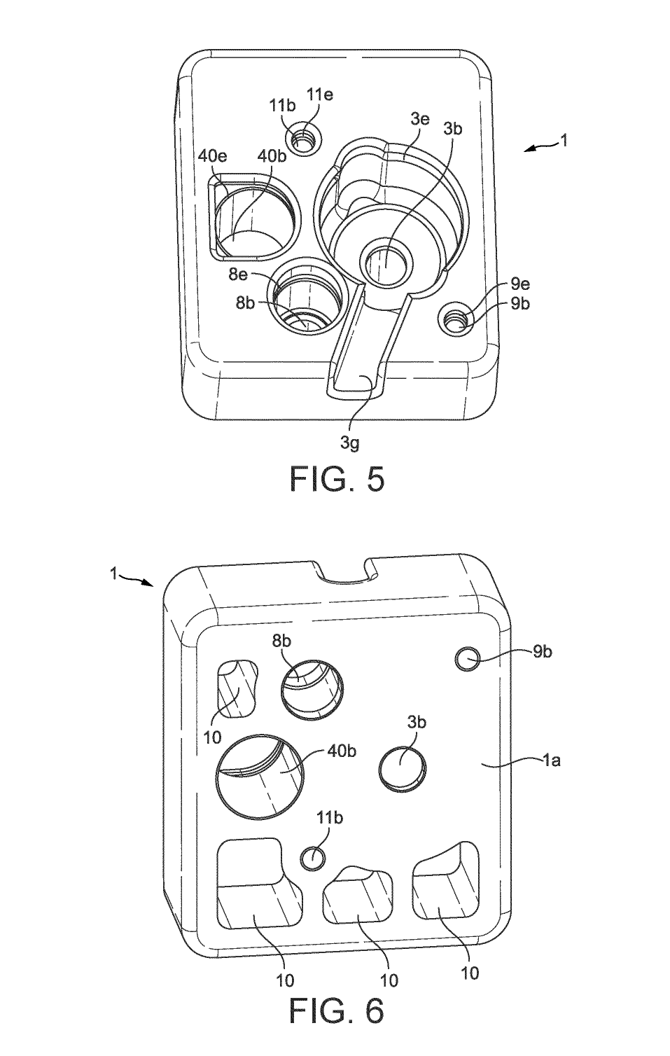

FIG. 4 is a bottom view of the beverage production device of FIG. 3 and in particular of the positioning device 1 where it is made apparent that the nozzles 40, 8, 9, 11 and the mixing chamber 3, 5 cross through the positioning device so that their outlets emerge at the bottom surface of the positioning device 1. In the preferred embodiment the positioning device is a plate member but other shapes could be implemented.

According to the invention the positioning device 1 is made of a flexible material so that the different nozzles 40, 8, 9, 11 and the mixing chamber outlet 3 can be easily removed from and then reconnected in. The flexible material is preferably an elastomeric or silicon material. To limit the cost of the material used for manufacturing the positioning device, some gaps 10 can be created in the volume of this means where no nozzle has to be placed.

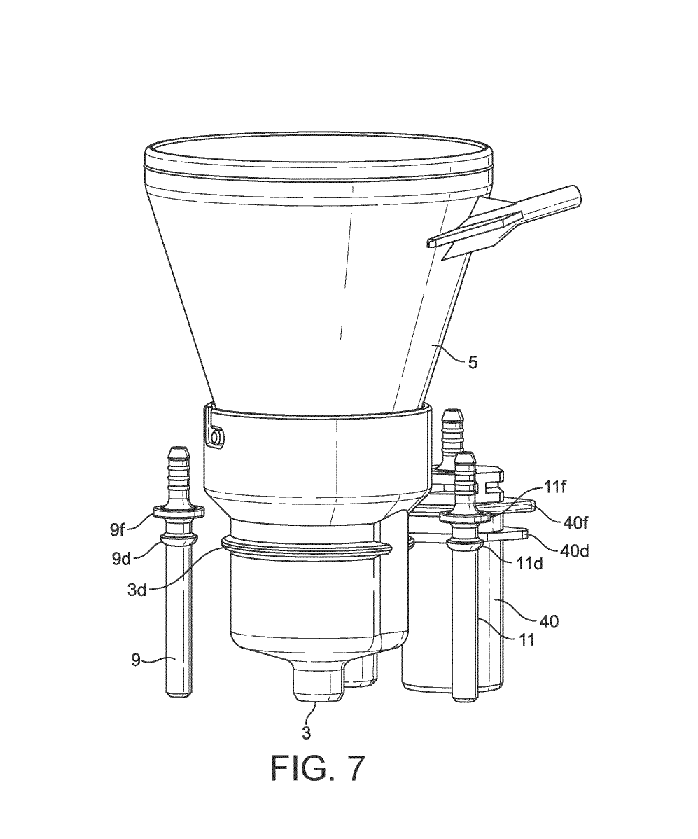

FIGS. 5 and 6 are views of the positioning device 1 alone that is from which the nozzles have been disconnected. It is made of only one piece of flexible material with holes 3b, 40b, 8b, 11b, 9b for removably plugging the corresponding nozzles 40, 8, 9, 11 and the mixing chamber outlet 3. Each hole 3b, 40b, 8b, 11b, 9b presents at least one recession 3e, 40e, 8e, 9e, 11e for cooperating with a flange on the nozzle that has respectively to be fixed inside. These flanges are made apparent in FIGS. 7 and 8 which are views of the nozzles 40, 8, 9, and of the mixing chamber 3, the other elements of the beverage mixing device having been made transparent. One nozzle 11 preferably presents a large diameter outlet for rapidly feeding a large amount of diluent in a cup; it can particularly apply for the preparation of a tea beverage from soluble tea powder or concentrate. Another nozzle 8 is preferably configured for delivering a spray of diluent in the cup; it can particularly apply for controlling the size of the bubbles on a foamed beverage in the cup. Another nozzle 9 can be dedicated for the cleaning of the beverage machine and in particular the emptying of the fluid system of the beverage preparation machine in which the present mixing device is used. It has no application for the preparation of the beverage itself. Another nozzle is preferably an assembly a several nozzles differently oriented one from the others so that they create diluent jets hitting the cup at different locations. Such an assembly is efficient for improving the mixing of the diluent with the food or beverage concentrate, the dissolution of the latter and also the frothing of the resulting beverage. FIGS. 5, 6, 7 and 8 make apparent that the nozzles and the mixing chamber outlet can easily been plugged in the flexible material of the positioning device; the flanges on them and the corresponding recessions in the positioning device holes prevent the nozzles and the mixing chamber outlet from sliding out during the use of the device. Yet due to the flexible nature of the material of the positioning device, an operator can easily remove the nozzles and the mixing chamber outlet by slightly bending and pulling out the nozzles extremities or the mixing chamber. Besides since the holes in the positioning device present dimensions respectively corresponding to the different nozzles and the mixing chamber outlet, the operator can rapidly plug the latter in the correct corresponding hole even if he is not used to the device. The place of the mixing chamber in the positioning device can also be rapidly identified in FIG. 5 because the positioning device presents a hollowing out 3g at its top face enabling the connection of one tubular member 5a to a bottom part of the chamber.

Nozzles 40, 9 and 11 can also present a second flange 40f, 9f, 11f that lies on the top surface of the positioning device 1 when the nozzles are fastened inside. These flanges help the operator for correctly positioning the nozzles inside the positioning device: it avoids that the operator does not sufficiently push the nozzles inside the positioning device. The operator knows that these flanges must lie on the top surface of the positioning device.

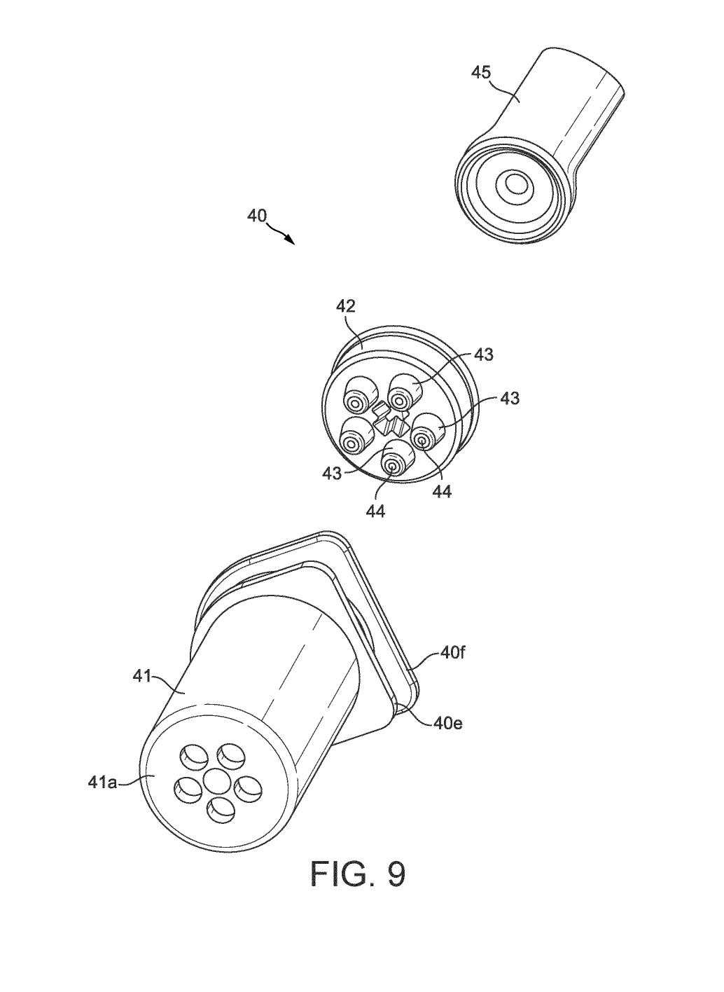

FIG. 9 represents the nozzle 40 which is an assembly of sub-nozzles 43 connected to a common diluent supply means 45. The assembly of sub-nozzles comprises an outer body 41 that is preferably made of a rigid material like a plastic (e.g. PA: polyamide). This outer body is generally a cylinder of which top extremity is opened and of which bottom extremity presents holes for each of the sub-nozzles 43. This outer body carries the flanges 40d and 40f for fixing the nozzle 40 in the positioning device 1. The assembly of sub-nozzles comprises also an inner body 42 wherein the channels of the sub-nozzles 43 are hollowed. The outlets 44 of said channels jut out the bottom surface of the inner body. During manufacturing the orientation of each of the sub-nozzles 43 can be designed in order to get a specific hitting of the water jets in the final cup. Preferably, and in relation with FIG. 1, the sub-nozzles 43 are designed so that two of the sub-nozzles 43 direct a diluent jet (A3, A4) to an inner side wall (13b) of the receptacle 13 and are arranged at different angles (α) with respect to the vertical, and at least two of the sub-nozzles 43 are designed to direct a diluent jet (A1, A2) to the bottom of the receptacle 13a and are arranged at different angles (β) with respect to the vertical. The length of the channels of the sub-nozzles 43 jutting out the inner body bottom surface and the thickness of the bottom extremity of the outer body are designed so that the channels of the sub-nozzles 43 slightly project beyond the outer body bottom surface 41a. The inner body 42 is made of a flexible material. It presents dimensions such that it is able to slide in the outer body for manufacturing and for maintenance or cleaning. It presents the smallest thickness as possible to limit manufacturing cost due to the nature of the flexible material. The nozzle 40 also comprises a diluent supply means 45 comprising a channel for guiding the diluent to the channels 43.

Due to the fact that the inner body 42 is removable from the outer body, it can be replaced by another inner body presenting different number of sub-nozzles or different orientation of the sub-nozzles to adapt the beverage mixing device to different cup shapes or sizes for example.

| | |
|---|---|
| 1 | positioning device |
| 1a | positioning device bottom surface |
| 2 | plate member |
| 3 | mixing chamber outlet |
| 40, 11, | nozzles |
| 4a, 5a, 8a, 11a | tubular members |
| 3b, 40b, 5b, 8b, 9b, | holes |
| 11b | |
| 3d, 40d, 8d, 9d, 11d | flange |
| 3e, 40e, 8e, 9e, 11e | recession |
| 3g | hollowing out |
| 40f, 9f, 11f | flange |
| 5 | mixing chamber |
| 51 | mixing chamber top opening |
| 6 | diluent supply means |
| 6a | diluent tank |
| 6b | pump |
| 6c | boiler |
| 7 | control unit |
| 8 | spray nozzle |
| 9 | rinsing nozzle |
| 10 | gaps |
| 13 | receptacle |
| 13a | bottom portion of receptacle |
| 13b | sidewall portion of receptacle |
| 20 | prior art plate member |
| 23, 24, 25 | valve members |
| 40 | assembly of sub-nozzles |
| 41 | outer body |
| 41a | outer body bottom surface |
| 42 | inner body |
| 43 | sub-nozzles |
| 44 | outlets of channels |
| 45 | diluent supply means |
| A2, A4 | jets of diluent |

The beverage mixing device of the present invention presents the advantage of proposing a positioning device in which the different nozzles of the mixing device can be easily fastened or removed without specific tool without error from the operator. The time for disconnection and reconnection is also reduced. This easy connection is helpful for the maintenance of the beverage mixing device when some nozzles must repaired or upgraded.

The positioning device of the device also present the advantage of setting the vertical position of the nozzles so that the nozzle outlets slightly project beyond the bottom surface of the positioning device. Consequently this bottom surface is almost flat and can be very easily cleaned by the operator with a sponge. Hygiene is improved.

1-15. (canceled)

16. A beverage production device for preparing a beverage by introducing water in a receptacle containing a beverage concentrate, the beverage production device comprising:
a plurality of nozzles for injecting at least one liquid into the receptacle,
at least one liquid supply connected to the nozzles,
the nozzles are removably fixed in a positioning device, the positioning device being made of a flexible material, and
the positioning device presents holes for removably plugging the nozzles.

17. A beverage production device according to claim 16, wherein the holes of the positioning device have dimensions corresponding to the external dimensions of their respective nozzles.

18. A beverage production device according to claim 16, wherein at least one of the nozzles presents at least one flange fitting in at least one recession of its respective hole in the positioning device when the nozzle is fixed in the hole.

19. A beverage production device according to claim 16, wherein at least one of the nozzles is connected to the liquid supply through a flexible tube.

20. A beverage production device according to claim 16, wherein the flexible material of the positioning device is a rubber or as soft thermoplastic.

21. A beverage production device according to claim 16, wherein the flexible material of the positioning device is an elastomeric or silicone material.

22. A beverage production device according to claim 16, wherein the positioning device presents a flat bottom surface and the outlet nozzles are fixed in the positioning device so that they slightly project beyond the bottom surface.

23. A beverage production device according to claim 16, wherein at least one of the nozzles removably fixed in the positioning device is an assembly of sub-nozzles connected to common liquid supply.

24. A beverage production device according to claim 16, wherein:
at least two of the sub-nozzles are designed to direct a diluent jet to an inner side wall of the receptacle and the sub-nozzles are arranged at different angles with respect to the vertical; and
at least two of the sub-nozzles are designed to direct a diluent jet to the bottom of the receptacle and the sub-nozzles are arranged at different angles with respect to the vertical.

25. A beverage production device according to claim 16, wherein an assembly of sub-nozzles comprises an outer body made of a rigid material and an inner body made of a flexible material and wherein the channels of the sub-nozzles are hollowed in the inner body and wherein the outlets of the channels extend through the bottom of the outer body and slightly project beyond the outer body bottom surface.

26. A beverage production device according to claim 16, wherein at least one of the nozzles removably fixed in the positioning device is a spray nozzle which is designed to provide a spray to the receptacle.

27. A beverage production device according to claim 16, wherein at least one of the nozzles removably fixed in the positioning device is the outlet of a mixing chamber.

28. A beverage production device according to claim 16, wherein except the at least one nozzle that is the outlet of a mixing chamber, all the other nozzles are connected to the same water supply.

29. Method for quick disconnecting or fastening a plurality of nozzles of a beverage production device for injecting at least water into a receptacle comprising:
providing a positioning device made of a flexible material and comprising holes for removably plugging the nozzles, and
unplugging or plugging the nozzles in holes of the positioning device.
